(19) United States
(12) Patent Application Publication
(10) Pub. No.: US 2017/0284846 A1
(43) Pub. Date: Oct. 5, 2017

(54) LOW COST HEATING REGULATION CIRCUIT FOR SELF-HEATING FLOW MEMS

(71) Applicant: Honeywell International Inc., Morris Plains, NJ (US)

(72) Inventor: Andrew J. Milley, Hilliard, OH (US)

(21) Appl. No.: 15/088,637

(22) Filed: Apr. 1, 2016

(51) Int. Cl. G01F 1/69

(52) U.S. Cl. CPC G01F 1/69

(57) ABSTRACT

Traditional flow sensors include an upstream resistive sensor element, a downstream resistive sensor element and an intervening heater resistive element. To help reduce the size and/or cost of such flow sensor, it is contemplated that the heater resistor may be eliminated. When so provided, the space required for the heater resistive element, as well as the corresponding heater control circuit, may be eliminated. This can reduce the cost, size and complexity of the flow sensor. Coupling a resistive sensor element of such flow sensor to ground through a low temperature coefficient of resistance (TCR) resistor can reduce the variation of span of an output of the flow sensor which can improve resolution and accuracy of such sensor.

### TECHNICAL FIELD

The disclosure relates generally to sensors, and more particularly, to flow sensors that are configured to sense the flow of a fluid in a flow channel.

### BACKGROUND

Flow sensors are used to sense fluid flow, and in some cases, provide flow signals that can be used for instrumentation and/or control. Flow sensors are used in a wide variety of applications including industrial applications, medical applications, engine control applications, military applications, and aeronautical applications, to name just a few.

### SUMMARY

The disclosure relates generally to sensors, and more particularly, to flow sensors. Traditional flow sensors include an upstream resistive sensor element, a downstream resistive sensor element and an intervening heater resistive element. To help reduce the size and/or cost of such flow sensor, it is contemplated that the heater resistor may be eliminated. When so provided, the space required for the heater resistive element, as well as the corresponding heater control circuit, may be eliminated. This can reduce the cost, size and complexity of the flow sensor. Further, at least one of the resistive sensor elements may be coupled to ground through a low temperature coefficient of resistance (TCR) resistor which can reduce variation of span in the output of the flow sensor which in turn can improve resolution and accuracy of the flow sensor.

In one example, a flow sensor may be provided that has an upstream self-heating sensor element and a downstream self-heating sensor element, with no intervening heater element. In some cases, the upstream resistive element and the downstream resistive element are operatively connected in a bridge circuit. The bridge circuit may be configured to supply a current to each of the upstream resistive element and the downstream resistive element that causes resistive heating such that both the upstream resistive element and the downstream resistive element are heated above the ambient temperature of the fluid flowing through a flow channel. When fluid flow is present in a flow channel, the fluid flow causes the temperature of the upstream resistive element to be lower than the temperature of the downstream resistive element. The difference in temperature causes an imbalance in the bridge circuit that is related to the flow rate of the fluid flowing though the flow channel.

A low TCR resistor can connect the bridge circuit to ground. The use of the low TCR resistor in this configuration can improve the resolution and accuracy of the flow sensor across the range of operating temperatures of the flow sensor, as the voltage division across the series of the bridge circuit and the low TCR resistor changes with temperature in a way that at least partially compensates undesirable span variation of output of the flow sensor with changes in temperature.

The above summary is not intended to describe each and every disclosed illustrative example or every implementation of the disclosure. The Description that follows more particularly exemplifies various illustrative embodiments.

### BRIEF DESCRIPTION OF THE FIGURES

The following description should be read with reference to the drawings. The drawings, which are not necessarily to scale, depict selected illustrative embodiments and are not intended to limit the scope of the disclosure. The disclosure may be more completely understood in consideration of the following description of various illustrative embodiments in connection with the accompanying drawings, in which:

FIG. 1 is a schematic cross-sectional view of an example flow sensing device;

FIG. 2 is a schematic circuit diagram of an example prior art flow sensor;

FIG. 3 is a top view of an example prior art flow sensor die;

FIG. 4 is a schematic circuit diagram of an illustrative flow sensor with one or more self heating resistive elements;

FIG. 5 is a top view of an illustrative flow sensor die with one or more self heating resistive elements;

FIG. 6 is a chart showing sensitivity versus flow rate of a prior art flow sensor die such as shown in FIG. 3 at various heater voltages; and

FIG. 7 is a chart showing sensitivity versus flow rate of a flow sensor die with one or more self heating resistive elements such as shown in FIG. 5 at various bridge supply voltages.

### DESCRIPTION

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives that may be utilized.

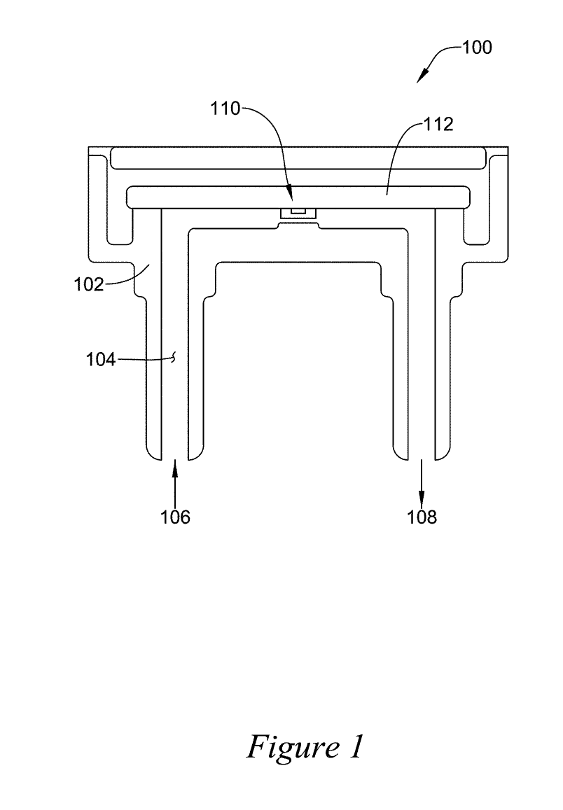

FIG. 1 is a schematic cross-sectional view of an example flow sensing device 100. The illustrative flow sensing device 100 includes a flow sensing device body 102 that defines a flow channel 104 having first end 106 and a second end 108. A fluid may flow through the flow channel 104 from, for example, the first end 106 to the second end 108 and past a flow sensor 110. The flow sensor 110 may sense the flow of the fluid passing over the flow sensor 110, and provide one or more output signals indicative of that flow. In some cases, the flow sensor 110 may provide one or more output signals that identity the flow rate of the fluid passing over the flow sensor 110. It is understood that a fluid may be a liquid, a gas, a vapor, and/or air. Under some circumstances, solids may behave like fluids and flow, for example, fluidized cement particles, fluidized flour particles, and grain.

While not required, the flow sensor 110 may include a flow sensor die that is mounted to a substrate 112. The substrate 112 may be mounted in the flow sensing device body 102. In some cases, some of the support circuitry for the flow sensor die may be located on the substrate 112 and/or may be located outside of the flow sensing device 100 altogether (e.g. located in a device that uses the output of the flow sensing device 100). FIG. 1 shows one example configuration of a flow sensing device. It should be recognized that such flow sensing devices can and do assume a wide variety of different configurations, depending on the application.

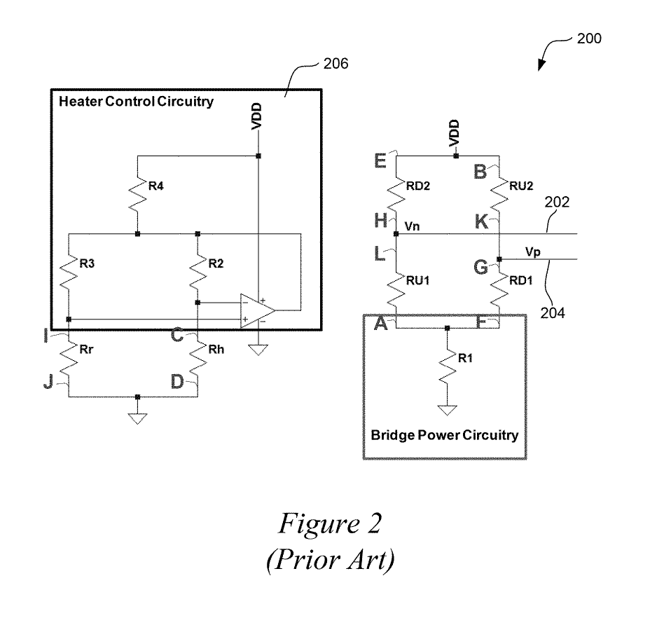

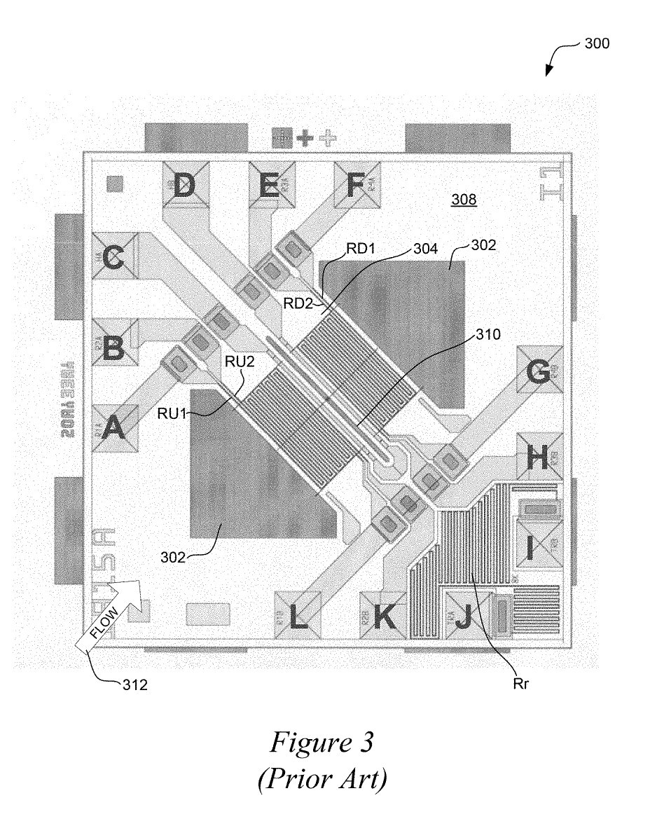

FIG. 2 is a schematic circuit diagram of an example prior art flow sensor 200. The example flow sensor 200 includes two upstream resistive elements RU1 and RU2 and two downstream resistive elements RD1 and RD2 connected in a full Wheatstone bridge configuration. The two upstream resistive elements RU1 and RU2 are positioned upstream of the two downstream resistive elements RD1 and RD2 within a flow channel, as best shown in FIG. 3. In the example shown, RU1 is connected between nodes L and A, RU2 is connected between nodes B and K, RD1 is connected between nodes G and F, and RD2 is connected between nodes E and H. A differential output of the bridge is taken between nodes Vn 202 and Vp 204. During use, a supply voltage, such as 2.4 volts, is provided to nodes E and B, and ground is connected to nodes A and F, either directly or through a resistor R1.

The example flow sensor 200 of FIG. 2 also includes a heater resistor Rh. Heater resistor Rh is connected between nodes C and D as shown. The heater resistor Rh is physically positioned between the upstream resistive elements RU1 and RU2 and the downstream resistive elements RD1 and RD2, as best shown in FIG. 3. The heater resistor Rh is heated by a heater control circuit 206. The heater resistor Rh typically has a resistance that is significantly lower than the nominal resistance of the resistive elements RU1, RU2, RD1 and RD2, such as 200 ohms. Resistive elements RU1, RU2, RD1 and RD2 may have a nominal resistance of, for example, 2.5 K ohms.

When no flow is present, the heater resistor Rh heats the fluid in the flow channel, which through conduction and convection, evenly heats the resistive elements RU1, RU2, RD1 and RD2. Since all of the resistive elements RU1, RU2, RD1 and RD2 are heated evenly, the bridge circuit remains in balance. However, when flow is present, the upstream resistive elements RU1 and RU2 are lowered in temperature relative to the downstream resistive elements RD1 and RD2. As the flow rate of the fluid in the flow channel increases, the difference in temperature between the upstream resistive elements RU1 and RU2 and the downstream resistive elements RD1 and RD2 increases. This difference in temperature causes the downstream resistive elements RD1 and RD2 to have a higher resistance than the upstream resistive elements RU1 and RU2 (assuming a positive temperature coefficient), thereby causing the bridge to become imbalanced. This imbalance produces a differential output signal between Vp 204 and Vn 202 that increases with flow rate and is monotonic with flow rate. In some cases, a sensing circuit (not shown) may receive Vp 204 and Vn 202, and may perform some compensation and/or linearization before providing a flow sensor output signal, if desired.

The example flow sensor 200 also includes a temperature reference resistor Rr. Temperature reference resistor Rr is connected between nodes I and J. The reference resistor Rr may have a nominal resistance of, say, 4 K ohms. The heater control circuit 206 controls the temperature of the heater resistor Rh to be above a reference (or ambient) temperature of the fluid sensed by reference resistor Rr. In most cases, it is desirable to heat the heater resistor Rh some amount (e.g. 200 degrees F.) above the ambient temperature of the fluid in the flow channel to increase the signal-to-noise ratio of the flow sensor.

FIG. 3 is a top view of an example prior art flow sensor die 300. The flow sensor die has an etched cavity 302 that extends under a membrane 304. The etched cavity 302 helps to thermally isolate the membrane 304 from the substrate 308 of the flow sensor die 300. The example flow sensor die 300 includes a slit 310 through the membrane 304 that extends transversely across the membrane 304. During use, the flow sensor die 300 is positioned in a flow channel.

To help explain the operation of the flow sensor die 300, it is assumed that fluid flows over the flow sensor die 300 in the direction indicated by arrow 312. When so provided, the two upstream resistive elements RU1 and RU2 are positioned on the membrane 304 upstream of the slit 310, and the two downstream resistive elements RD1 and RD2 are positioned on the membrane 304 downstream of the slit 310. The heater resistor Rh is positioned between the upstream resistive elements RU1 and RU2 and the downstream resistive elements RD1 and RD2. In the example shown, the heater resistor Rh includes two legs connected in series, with one leg positioned on either side of the slit 310. The example flow sensor die 300 is one possible layout of the schematic circuit diagram shown in FIG. 2, with the corresponding nodes indicated (A-L). The example flow sensor die 300 does not include the heater control circuit 206, the connection between nodes H-L, the connection between nodes K-G, the connection between nodes E-B, or the connection between nodes A-F. This example flow sensor die 300 is considered a test die, and these connections are intended to be made external to the flow sensor die 300. However, they could be made on the flow sensor die 300 if desired.

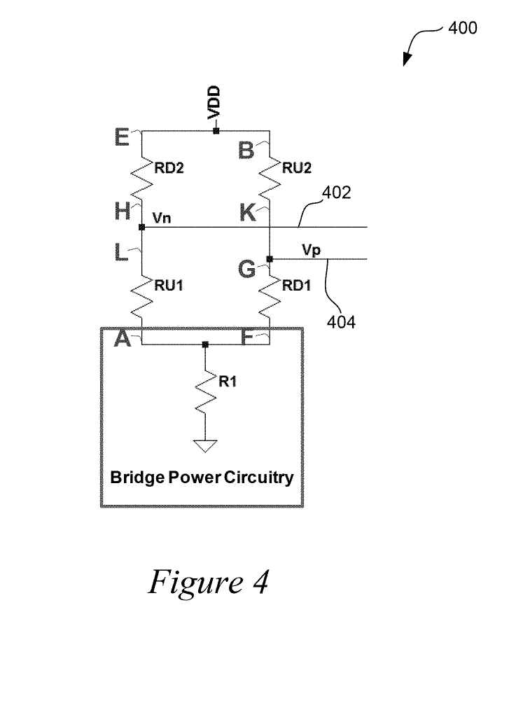

To help reduce the size and/or cost of the prior art flow sensor die 300 discussed above, it is contemplated that the heater resistor Rh may be eliminated. When so provided, the space required for the heater resistor Rh, as well as the heater control circuit 206, may be eliminated. FIG. 4 is a schematic circuit diagram of an illustrative flow sensor 400 with this modification. The flow sensor 400 eliminates the heater resistor Rh and the corresponding heater control circuit discussed above. In order to provide the necessary heat to make the flow measurement, it is contemplated that one or more of the resistive elements RU1, RU2, RD1 and RD2 may be self heating. That is, one or more resistive elements RU1, RU2, RD1 and RD2 may not only heat the fluid but also sense the temperature of the fluid. In one example, all of the resistive elements RU1, RU2, RD1 and RD2 are self heating (i.e. heat and sense). In other instances, only one upstream resistive element RU1 or RU2 may be self heating, both upstream resistive elements RU1 and RU2 may be self heating, only one upstream resistive element RU1 or RU2 and only one downstream resistive element RD1 or RD2 may be self heating, or any other combination of resistive elements may be self heating so long as at least one upstream resistive element is self heating. In some cases, only one upstream resistive element and only one downstream resistive element is provided, rather than two.

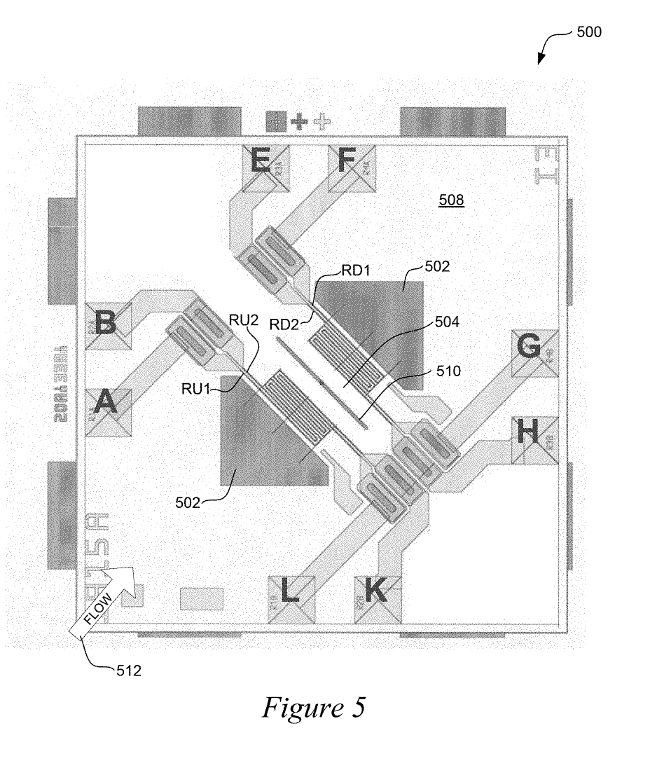

In the example shown, the illustrative flow sensor 400 includes two upstream resistive elements RU1 and RU2 and two downstream resistive elements RD1 and RD2 connected in a full Wheatstone bridge configuration. It is contemplated, however, that only one upstream resistive element RU1 and one downstream resistive element RD2 may be provided, which in some cases, can be connected in a half-bridge or other configuration. In the example shown in FIG. 4, the two upstream resistive elements RU1 and RU2 are positioned upstream of the two downstream resistive elements RD1 and RD2 within a flow channel, as best shown in FIG. 5. RU1 is connected between nodes L and A, RU2 is connected between nodes B and K, RD1 is connected between nodes G and F, and RD2 is connected between nodes E and H. A differential output of the bridge is taken between nodes Vn 402 and Vp 404. During use, a supply voltage, such as 2.4 volts, may be provided to nodes E and B, and ground may be connected to nodes A and F, either directly or through a resistor R1.

In most cases, resistive elements RU1, RU2, RD1 and RD2 have substantially the same temperature coefficient (positive or negative). Substantially the same here means plus or minus ten (10) percent. In some cases, resistive elements RU1, RU2, RD1 and RD2 have temperature coefficients that are within 1 percent or less of each other. Also, resistive elements RU1, RU2, RD1 and RD2 may have substantially the same nominal resistance, such as about 500 ohms. In some cases, resistive elements RU1, RU2, RD1 and RD2 may have nominal resistance valves that are within twenty (20) percent, ten (10) percent, five (5) percent, or one (1) percent or less of each other. In some cases, the resistive elements RU1, RU2, RD1 and RD2 may be formed from a common set of one or more layers. Notably, in FIG. 5, the two upstream resistive elements RU1 and RU2 and the two downstream resistive elements RD1 and RD2 are not separated by an intervening heater resistor Rh, and in particular, a heater resistor Rh that has a significantly lower resistance than the resistance of the resistive elements. Significantly less means at least twenty (20) percent less.

For discussion purposes, it is assumed that all of the resistive elements RU1, RU2, RD1 and RD2 are self heating. When no flow is present, the resistive elements RU1, RU2, RD1 and RD2 heat the fluid in the flow channel, which through conduction and convection, evenly heats the resistive elements RU1, RU2, RD1 and RD2. Since all of the resistive elements RU1, RU2, RD1 and RD2 are heated evenly, the bridge circuit remains in balance. However, when flow is present, the upstream resistive elements RU1 and RU2 are lowered in temperature relative to the downstream resistive elements RD1 and RD2. As the flow rate of the fluid in the flow channel increases, the difference in temperature between the upstream resistive elements RU1 and RU2 and the downstream resistive elements RD1 and RD2 increases. This difference in temperature causes the downstream resistive elements RD1 and RD2 to have a higher resistance than the upstream resistive elements RU1 and RU2 (assuming a positive temperature coefficient), thereby causing the bridge to become imbalanced. This imbalance produces a differential output signal between Vp 404 and Vn 402 that increases with flow rate and is monotonic with flow rate. In some cases, a sensing circuit (not shown) may receive Vp 404 and Vn 402, and may perform some compensation and/or linearization before providing a flow sensor output signal, if desired.

In a preferred embodiment, the electrical ground is connected to nodes A and F through the resistor R1, and R1 is a low temperature coefficient of resistance (TCR) resistor. The TCR of R1 may be an order of magnitude (i.e., 10 times) less than the TCR of the bridge resistive elements (RD1, RD2, RU1, and RU2). In an embodiment, the TCR of the bridge resistors may be about 0.003/° C. (i.e., 3000 ppm/° C.) or greater, and the TCR of resistor R1 may be less than or equal to 0.0003/° C. (i.e., 300 ppm/° C.). In an embodiment, the TCR of R1 may be two orders of magnitude (i.e., 100 times) less than the TCR of the bridge resistance elements, for example the TCR of R1 may be less than or equal to 0.00003/° C. (i.e., 30 ppm/° C.). In an embodiment, the TRC of R1 is less than or about 0.0001/° C. (i.e., 100 ppm/° C.). It is understood that it is undesirable to make the flow sensor 400 insensitive to changes in temperature: it is the temperature differences in the bridge resistive elements that causes the bridge circuit to be imbalanced and to provide the indication of flow rate.

The resistance of a resistor and/or resistive element may vary with temperature. The classic modeling of this effect is given by equation 1:

R=R_{ref}[1+α(T−T_{ref})] EQ 1

where R is the resistance of the resistor at a temperature T; R_{ref} is the resistance of the resistor at a reference temperature T_{ref} (e.g., at 20° C.); and α is the TCR of the material of which the resistor is composed.

With a constant voltage over the bridge circuit (i.e., resistive elements RD1, RD2, RU1, and RU2), the span or output range of the bridge circuit may vary significantly with temperature of the fluid media that the flow sensor 400 is intended to measure. This is implied by the understanding that less current flows in the resistive elements of the bridge circuit when the voltage remains constant but the resistance of the individual resistance elements of the bridge circuit increases (Ohm's Law says voltage is proportional to current times resistance, hence more resistance with constant voltage implies less current). This implies that less heat is injected into the fluid stream by the reduced current flowing in the resistive elements RD1, RD2, RU1, and RU2 (or a subset of these in some embodiments) as power lost in the resistors (hence heat injected into the fluid stream by the resistive elements RD1, RD2, RU1, and RU2 or a subset) is proportional to the square of current times the resistance (I²R): the effect of increased resistance is more than compensated by the reduced current because the effect of current change is squared.

As an example, for a fluid flow of 0 to 1 liter per minute at 25° C., the output of the bridge may range from 0 to 1 mV; for a fluid flow of 0 to 1 liter per minute at 70° C. the output of the bridge may range from 0 to 0.5 mV; and for a fluid flow of 0 to 1 liter per minute at −20° C. the output of the bridge may range from 0 to 2.0 mV. Such a large variation in span of the flow sensor 400 is undesirable in some applications. For example, in an application where the output of the bridge is sampled and digitized, the large range of span change over temperature can result in loss of resolution at higher temperatures. As an example, the digital processing may reserve the highest digital representation value—for example 65535 for a 16 bit digital representation—for the maximum bridge output of 2.0 mV when the flow sensor 400 is operated in a fluid at −20° C. This means that when the flow sensor 400 is operated in a fluid at 70° C., the digital representation may only range over 0 to about 16383, thereby losing resolution. Additionally, when conditioning such a digitized representation (compensating for offset and/or linearizing the digitized representation), the large range of span change over temperature can pose challenges for conditioning.

The present disclosure teaches connecting the bridge circuit (e.g., resistive elements RU1, RU2, RD1, and RD2 or a subset of these resistive elements in some embodiments) via a low TCR resistor R1 to ground. When the temperature of the fluid sensed by the sensor 400 varies, the series resistance of the bridge circuit (viewed as a lump sum resistance) changes more than the series resistance of the resistor R1, because the TCR of R1 is one order of magnitude less to two orders of magnitude less than the TCR of the bridge circuit resistance (the lump sum resistance of the bridge circuit resistive elements, e.g., RU1, RU2, RD1, and RD2 or a subset of these resistive elements in some embodiments). The result of incorporating a low TCR resistance resistor R1 is that as the temperature of the fluid sensed by the sensor 400 varies, the portion of the source voltage V_{DD} that is distributed to the bridge circuit and the portion of the source voltage V_{DD} that is distributed to the R1 resistance varies in a sense that offsets and moderates the undesirable span temperature dependence. Thus, as temperature increases, the series resistance of the bridge circuit increases more than the resistance of the low TCR resistor R1 increases and the voltage across the bridge circuit increases, raising the span of the bridge circuit (relative to what the span otherwise would be at the temperature without the low TCR resistor R1); as temperature decreases, the series resistance of the bridge circuit decreases more than the resistance of the low TCR resistor R1 decreases and the voltage across the bridge circuit decreases, lowering the span of the bridge circuit (relative to what the span otherwise would be at the temperature without the low TCR resistor R1). This results in less variation of span across the range of operating temperatures of the flow sensor 400.

By reducing the variation in span of the output of the bridge circuit by use of the low TCR resistor R1, the loss of resolution due to temperature variation during digitization of the bridge circuit output signal can be reduced and the difficulty of conditioning the digitized output of the bridge circuit across different temperatures is mitigated. For example, if the range of variation of span over the temperature range −20° C. to 70° C. without low TCR resistor R1 is 1:4; the range of variation of span over the same temperature range with low TCR resistor R1 may be 1:2, 1:1.4, 1:1.2; 1:1.1, or some other more modest ratio. In an embodiment, it is contemplated that the variation of span over the range of operating temperatures of the bridge circuit may be reduced by 70% to 80% by the use of the low TCR resistor R1. This reduction in variation of span can result in a more accurate fluid flow sensor or more accurate fluid flow calculation from the flow sensor output. The signal digitalization and conditioning may be performed by an application specific integrated circuit (ASIC).

FIG. 5 is a top view of an illustrative flow sensor die 500. The illustrative flow sensor die has an etched cavity 502 that extends under a membrane 504. The etched cavity 502 helps to thermally isolate the membrane 504 from the substrate 508 of the flow sensor die 500. The illustrative flow sensor die 500 includes a slit 510 that extends transversely across the membrane 304, but this is not required. During use, the illustrative flow sensor die 500 is positioned in a flow channel.

In an embodiment, the flow sensor die 500 may be less than 1 mm (millimeter) on each planar side (length and width) and less than 1 mm² in planar area. The flow sensor die 500 may be said to be a microelectromechanical system (MEMS) device. The term MEMS may also be referred to as micro-electro-mechanical systems or MicroElectroMechanical systems. MEMS devices, such as the flow sensor die 500, may be manufactured using fabrication technologies akin to or the same as those used in manufacturing semiconductors, for example, building the MEMS device through a deposition of material layers patterned by photolithography and etched to produce desired circuit and physical mechanical features and shapes. MEMS devices, such as the flow sensor die 500, may be referred to by the term micromachines (in Japan) or Micro Systems Technology (MST) (in Europe).

To help explain the operation of the flow sensor die 500, it is assumed that fluid flows over the flow sensor die 500 in the direction indicated by arrow 512. When so provided, the two upstream resistive elements RU1 and RU2 are positioned on the membrane 504 upstream of the slit 510, and the two downstream resistive elements RD1 and RD2 are positioned on the membrane 504 downstream of the slit 510. Note, there is no separate heater resistor Rh positioned between the upstream resistive elements RU1 and RU2 and the downstream resistive elements RD1 and RD2. The illustrative flow sensor die 500 shown in FIG. 5 is one possible layout of the schematic circuit diagram shown in FIG. 4, with the corresponding nodes indicated (A-B, E-H and K-L). The illustrative flow sensor die 500 also does not include heater control circuitry.

The illustrative flow sensor die 500 does not include the connection between nodes H-L, the connection between nodes K-G, the connection between nodes E-B, or the connection between A-F. This flow sensor die 500 is considered a test die, and these connections are intended to be made external to the flow sensor die 500 itself. In some cases, these connections may be made on the flow sensor die 500. To further reduce the size of the membrane 504, and thus the flow sensor die 500, it is contemplated that the two upstream resistive elements RU1 and RU2 may be moved closer to the two downstream resistive elements RD1 and RD2 that is shown in FIG. 5.

In an embodiment, the low TCR resistor R1 may be provided external to the flow sensor die 500. Alternatively, in another embodiment, the low TCR resistor R1 may be provided as part of the flow sensor die 500, e.g., as part of the MEMS device. Because the low TCR resistor R1 exhibits a TCR that is one order of magnitude to two orders of magnitude less than the TCR of the bridge circuit resistive elements, manufacturing of the low TCR resistor R1 may entail an additional manufacturing process step, for example an additional deposition process step and an additional etching step. The low TCR resistor R1 may be fabricated with a different material from the bridge circuit resistive elements. A first end of the low TCR resistor R1 may be connected on the flow sensor die 500 to node A and node F, and a second end of the low TCR resistor R1 may be connected to another node (not shown) of the flow sensor die 500 that may be connected to ground in an application of the flow sensor die 500. The bridge circuit output digitization and signal conditioning ASIC may be provided external to the flow sensor die 500 or, alternatively, may be integrated into the MEMS device containing the flow sensor die 500.

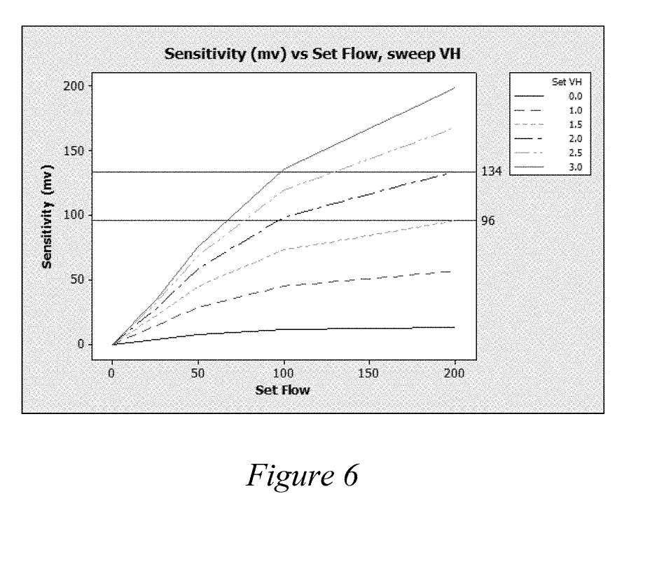

FIG. 6 is a chart showing sensitivity (differential bridge output) versus flow rate for a prior art flow sensor die such as that shown in FIG. 3 at various heater voltages. The bridge voltage was at 2.4 volts. As can be seen, the sensitivity at heater voltages of 1.5-2.0 volts produces a sensitivity (differential bridge output) in the range of about 96-134 my at flow rate of about 200.

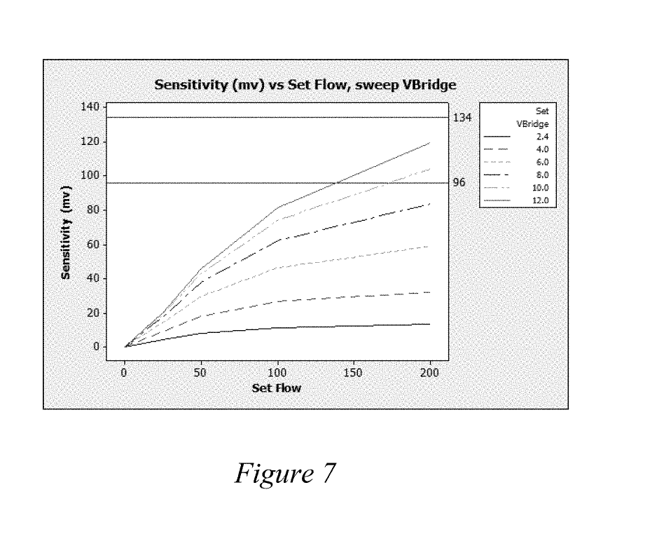

FIG. 7 is a chart showing sensitivity (differential bridge output) versus flow rate of a flow sensor die with four self heating resistive elements RU1, RU2, RD1 and RD2 such as shown in FIG. 5 at various bridge supply voltages. As can be seen, a similar sensitivity (differential bridge output) can be achieved to that shown in FIG. 6 by increasing the bridge voltage (VDD) to about 10-14 volts. Notably, the chart shown in FIG. 7 assumes that the resistance of the resistive elements RU1, RU2, RD1 and RD2 is the same as the resistance of the resistive elements RU1, RU2, RD1 and RD2 for the chart of FIG. 6 (2.4 K ohms). To reduce the bridge voltage that is required in FIG. 7, it is contemplated that the resistance of the resistive elements RU1, RU2, RD1 and RD2 of FIGS. 4-5 may be reduced, such as to 500 ohms (e.g. 300-900 ohms). This may allow each of the resistive elements RU1, RU2, RD1 and RD2 to produce a similar amount of heat but at a lower bridge voltage. It is believed that this should result in a similar sensitivity (differential bridge output) to that shown in FIG. 6 and at a similar bridge voltage (e.g. 2.4 volts).

The disclosure should not be considered limited to the particular examples described above. Various modifications, equivalent processes, as well as numerous structures to which the disclosure can be applicable will be readily apparent to those of skill in the art upon review of the instant specification.

What is claimed is:

1. A flow sensor for sensing a fluid flow rate through a flow channel, the flow sensor comprising:
an upstream resistive element having a first resistance that changes with temperature and having a first temperature coefficient of resistance (TCR);
a downstream resistive element having a second resistance that changes with temperature and having a second TCR, wherein the downstream resistive element is situated downstream of the upstream resistive element in the flow channel and wherein the first TCR and the second TCR are substantially the same;
the upstream resistive element and the downstream resistive element are operatively connected in a bridge circuit, wherein the bridge circuit is configured to supply a current to each of the upstream resistive element and the downstream resistive element, wherein the current causes resistive heating in both the upstream resistive element and the downstream resistive element such that both the upstream resistive element and the downstream resistive element are heated above the ambient temperature of the fluid flowing through the flow channel, wherein the fluid flow through the flow channel causing the temperature of the upstream resistive element to be lower than the temperature of the downstream resistive element, wherein a difference in temperature between the upstream resistive element and the downstream resistive element causes an imbalance in the bridge circuit that is related to the fluid flow rate of the fluid flowing though the flow channel; and
a low TCR resistor having a third TCR that is at least an order of magnitude lower than the first TCR and at least an order of magnitude lower than the second TCR.

2. The flow sensor of claim 1, wherein the first resistance is substantially the same as the second resistance when the fluid flow rate is at zero.

3. The flow sensor of claim 1, wherein the upstream resistive element and the downstream resistive element are formed from a common set of one or more layers and the low TCR resistor is formed from a different set of one or more layers than the common set of one or more layers in which the upstream resistive element and the downstream resistive element are formed from.

4. The flow sensor of claim 1, wherein the third TCR is less than about 0.0003/° C.

5. The flow sensor of claim 1, wherein the third TCR is less than about 0.0001/° C.

6. The flow sensor of claim 1, wherein the variation in span of the output of the bridge circuit from −20° C. operating temperature to 70° C. operating temperature is less than 1.4:1.

7. A flow sensor device comprising:
a substrate;
a membrane suspended by the substrate;
an upstream resistive element situated on the membrane having a first temperature coefficient of resistance (TCR);
a downstream resistive element situated on the membrane adjacent the upstream resistive element having a second TCR, wherein the first TCR and the second TCR are substantially the same, with no intervening heater element positioned between the upstream resistive element and the downstream resistive element;
a first upstream node coupled to a first end of the upstream resistive element and a second upstream node coupled to a second end of the upstream resistive element;
a first downstream node coupled to a first end of the downstream resistive element and a second downstream node coupled to a second end of the downstream resistive element; and
a low TCR resistor coupled to one of the upstream resistive element and the downstream resistive element having a third TCR where the third TCR is at least an order of magnitude less than the first TCR and is at least an order of magnitude less than the second TCR;
wherein the upstream resistive element has an electrical resistance between the first upstream node and the second upstream node and the downstream resistive element has an electrical resistance between the first downstream node and the second downstream node; and
wherein the resistance of the upstream resistive element is within 20 percent or less of the resistance of the downstream resistive element when the upstream resistive element is at the same temperature as the downstream resistive element.

8. The flow sensor device of claim 7, wherein the resistance of the upstream resistive element is within 10 percent or less of the resistance of the downstream resistive element when the upstream resistive element is at the same temperature as the downstream resistive element.

9. The flow sensor device of claim 7, wherein the resistance of the upstream resistive element is within 1 percent or less of the resistance of the downstream resistive element when the upstream resistive element is at the same temperature as the downstream resistive element.

10. The flow sensor device of claim 7, wherein the low TCR resistor couples the substrate to ground.

11. The flow sensor device of claim 7, wherein the low TCR resistor has a TCR of 0.0003/° C. or less.

12. A micromechanicalelectrical system (MEMS) flow sensor die comprising:
a substrate, wherein the substrate is 1 square millimeter or less in planar area;
a membrane suspended by the substrate;
an upstream resistive element situated on the membrane;
a downstream resistive element situated on the membrane adjacent the upstream resistive element, with no intervening heater element positioned between the upstream resistive element and the downstream resistive element.

13. The flow sensor die of claim 12, further comprising:
a slit formed through the membrane between the upstream resistive element and the downstream resistive element.

14. The flow sensor die of claim 12, wherein the upstream resistive element and the downstream resistive element have a resistance in the range of 300-900 ohms.

15. The flow sensor die of claim 12, wherein the upstream resistive element and the downstream resistive element are connected in a Wheatstone bridge configuration.

16. The flow sensor die of claim 15, wherein the upstream resistive element and the downstream resistive element have substantially the same temperature coefficient of resistance (TCR), further comprising a low TCR resistor that connects to one end of the Wheatstone bridge configuration, wherein the low TCR resistor has a TCR that is an order of magnitude less than the TCR of the upstream resistive element and the downstream resistive element.

17. The flow sensor die of claim 16, wherein the low TCR resistor has a TCR that is less than about 0.0003/° C.

18. The flow sensor die of claim 17, wherein the TCR of the upstream resistive element and the downstream resistive element is at least about 0.003/° C.

19. The flow sensor die of claim 16, the low TCR resistor comprises a material that is different from the material the upstream resistive element and the downstream resistive element are comprised of.

20. The flow sensor die of claim 16, wherein the variation in span of the output of the Wheatstone bridge configuration from −20° C. operating temperature to 70° C. operating temperature is less than 1.4:1.
